(19) United States
(12) Patent Application Publication
(10) Pub. No.: US 2017/0008229 A1
(43) Pub. Date: Jan. 12, 2017

(54) UV PEN

(71) Applicants: Reed Quinn, Orem, UT (US); Chris Quinn, Orem, UT (US)

(72) Inventors: Reed Quinn, Orem, UT (US); Chris Quinn, Orem, UT (US)

(73) Assignee: FIBER FIX USA, LLC, Orem, UT (US)

(21) Appl. No.: 14/794,607

(22) Filed: Jul. 8, 2015

(51) Int. Cl. B29C 67/00; B29C 35/08; B29C 47/00

(52) U.S. Cl. CPC B29C 67/0055; B29C 47/0002; B29C 35/0805; B29C 2035/0827; B29K 2033/04

(57) ABSTRACT

A UV pen for repairing inanimate objects. The UV pen includes a cavity. The UV pens also includes a UV activated hardening material. The UV activated hardening material is stored within the cavity and hardens when exposed to UV radiation.

### CROSS-REFERENCE TO RELATED APPLICATIONS

Not applicable.

### BACKGROUND OF THE INVENTION

When faced with the problem of a broken or weakened inanimate object, such as a hole in a metal container, a user generally has the choice of attempting to repair the item using conventional methods or replacement parts, or discarding the item and purchasing a replacement. Neither approach is particularly satisfactory.

For example, if the user should choose to replace the item, the user will incur the expense of the item and possibly other expenses, such as shipping and taxes. In terms of intangibles, the user must spend time to locate and purchase the item, when that time might be profitably employed in other pursuits. In other instances, where the item may be relatively uncommon, it may be difficult or impossible to find a suitable replacement. In such an instance, the user may have to strike a compromise and attempt to find a substitute that may or may not be fully satisfactory for its intended use.

Rather than attempting to find a replacement for the broken item, the user may attempt to repair the item, and thereby avoid some of the difficulties noted above. However, depending upon the item to be repaired and the type of damage, some breaks or other damage may not lend themselves to a wide range of remedies. Thus, a user may attempt to affect a repair of a broken item with materials such as duct tape or electrician's tape; however, such materials can deteriorate relatively quickly due to exposure to conditions such as moisture, sunlight, and abrasion and don't do anything to stabilize the underlying object. Moreover, where repair of a relatively rigid item, such as a tool handle for example, is desired, flexible materials such as the aforementioned tapes may not provide for a particularly effective repair.

Accordingly, there is a need in the art for a repair material that can allow a user to repair rather than replace an item. In addition, there is a need in the art for a repair material that can provide a rigid structure during the repair. Moreover, there is a need in the art for a repair material which adheres directly to the object in need of repair.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a UV pen for repairing inanimate objects. The UV pen includes a cavity. The UV pens also includes a UV activated hardening material. The UV activated hardening material is stored within the cavity and hardens when exposed to UV radiation.

Another example embodiment includes a UV pen for repairing inanimate objects. The UV pen includes a cavity configured to deform under pressure. The UV pens also includes a UV activated hardening material. The UV activated hardening material is stored within the cavity and hardens when exposed to UV radiation. Further the UV activated hardening material is amber yellow before curing and is transparent after curing. The UV pen further includes a tip. The tip is connected to the cavity and allows UV activated hardening material to exit the cavity when pressure is placed on the cavity. The UV pen additionally includes a UV light.

Another example embodiment includes a repair kit for repairing an inanimate object. The repair kit include a UV pen. The UV pen includes a cavity configured to deform under pressure. The UV pens also includes a UV activated hardening material. The UV activated hardening material is stored within the cavity and hardens when exposed to UV radiation. Further the UV activated hardening material is amber yellow before curing and is transparent after curing. The UV pen further includes a tip. The tip is connected to the cavity and allows UV activated hardening material to exit the cavity when pressure is placed on the cavity. The UV pen additionally includes a UV light. The repair kit also includes a pair of gloves and instructions. The repair kit further includes a surface preparation material configured to allow a user to finish the UV hardening material after curing.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of an example of a UV pen;

FIG. 1B illustrates an exploded view of an example of a UV pen;

FIG. 2 illustrates an example of a UV pen in use; and

FIG. 3 illustrates an example of a repair kit.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

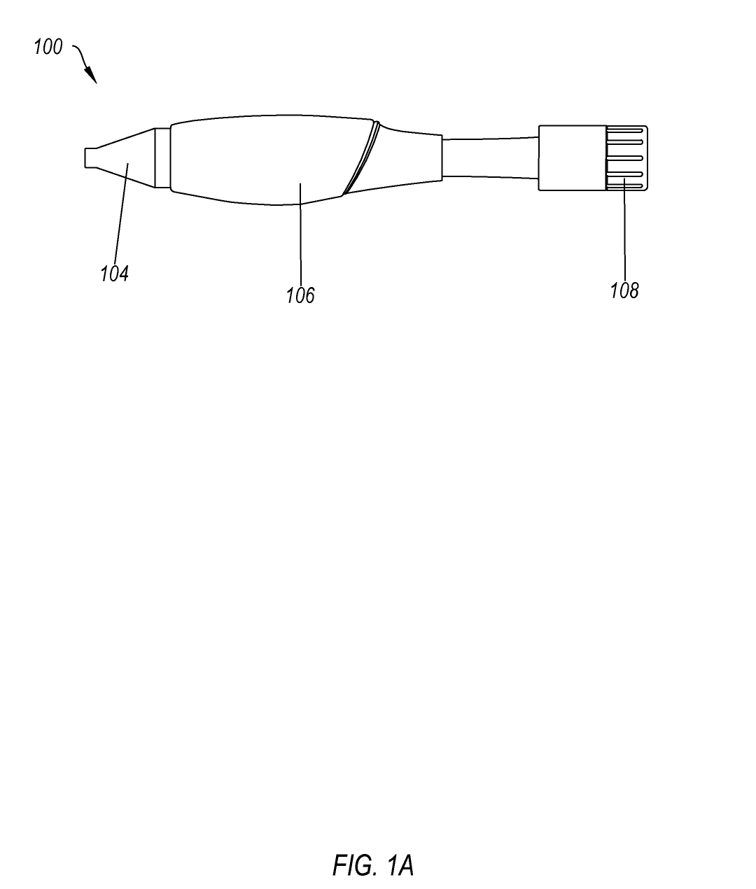

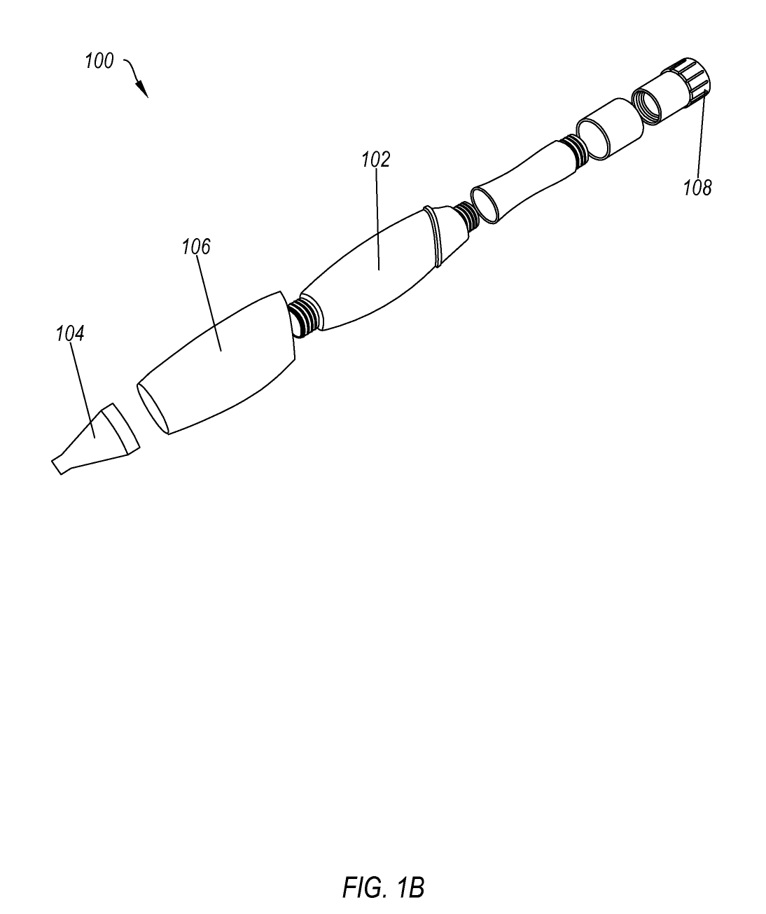

FIGS. 1A and 1B (collectively “FIG. 1”) illustrate an example of a UV pen 100. FIG. 1A illustrates a side view of an example of a UV pen 100; and FIG. 1B illustrates an exploded view of an example of a UV pen 100. The UV pen 100 can be employed in a wide variety of applications. For example, the UV pen 100 may be used to repair, temporarily or permanently, broken items. E.g., if a hole has been created in an object or the object has been thinned or otherwise damaged, the UV pen 100 can be used to replace the hole or weak spot. As the hardening material hardens it strengthens the item. Additionally or alternatively, the UV pen 100 may be used to strengthen an object or used for any other desired purpose.

In general, the UV pen 100 may be employed to affect repairs of broken items that may be rigid. As used herein, the term ‘repair’ is intended to be broadly construed and includes, but is not limited to: the joining of two pieces of an item that have partially or completely broken apart from each other and/or the covering of a hole, crack or fracture in an item or restore or straighten a bent or folded item.

General areas of application include industry, home and garden, sporting goods, recreation, landscaping, automotive, military and agriculture. For example, the UV pen 100 may be used in connection with a variety of different materials. Such materials include, but are not limited to, wood, metal, glass, plastic, rubber, composites, fiberglass, ceramic, concrete, and combinations of any of the foregoing. E.g., the UV pen 100 may be used to repair, temporarily or permanently, items where gaps exist or for securing two objects to one another, such as glasses frames or damaged cables or cords or for decorative purposes, such as for scrapbooking or glass works.

FIG. 1 shows that the UV pen 100 can include a cavity 102. The cavity 102 is a space that is capable of holding an inactivated UV activated hardening material, as described below. In particular, the cavity 102 stores the UV activated hardening material and prevents the activating material from reaching the UV activated hardening material so that it can be used when desired by the user. The cavity 102 is made of a flexible material which allows the user to compress the cavity 102, ejecting UV activated hardening material. Additionally or alternatively, the cavity 102 can include any other desired mechanism for ejecting the UV activated hardening material, such as a plunger that pushes the UV activated hardening material from the rear of the UV pen 100. Further, the cavity 102 can include a UV blocking material. That is, the cavity 102 can prevent UV radiation from reaching the UV activated hardening material.

FIG. 1 also shows that the UV pen 100 can include a tip 104. The tip 104 allows a user to precisely direct the placement of the UV activated hardening material. That is, the user is capable to direct exactly where the UV activated hardening material is placed by putting the tip 104 in the desired location then squeezing the cavity 102. The tip 104 can include a cap or other mechanism for preventing UV activated hardening material from exiting the UV pen 100 when not desired.

FIG. 1 further shows that the UV pen 100 can include a grip 106. The grip 106 can prevent slippage of the UV pen 100. In particular, the grip 106 can include rubber, polyurethane or any other desired non-slip material. Additionally or alternatively, the grip 106 can allow a user to put more precise pressure on the cavity 102 to more accurately eject the desired amount of material.

FIG. 1 additionally shows that the UV pen 100 can include a UV light 108. The UV light can include an LED bulb or other light source which emits UV radiation. For example, the UV light 108 can include a 1.6-2.2 W, 370-405 nm double chip low divergence angle UV LED. Low divergence angel ensures that the user can focus the light on the UV activated hardening material, minimizing cure time. A light-emitting diode (LED) is a two-lead semiconductor light source. It is a pn-junction diode, which emits light when activated. When a suitable voltage is applied to the leads, electrons are able to recombine with electron holes within the device, releasing energy in the form of photons. This effect is called electroluminescence, and the wavelength of the light (corresponding to the energy of the photon) is determined by the energy band gap of the semiconductor. An LED is often small in area (less than 1 mm²) and integrated optical components may be used to shape its radiation pattern.

LEDs have many advantages over incandescent light sources including lower energy consumption, longer lifetime, improved physical robustness, smaller size, and faster switching. Light-emitting diodes are now used in applications as diverse as aviation lighting, automotive headlamps, advertising, general lighting, traffic signals, and camera flashes. LEDs have allowed new text, video displays, and sensors to be developed, while their high switching rates are also useful in advanced communications technology.

Ultraviolet (UV) light is electromagnetic radiation with a wavelength from 400 nm to 10 nm, shorter than that of visible light but longer than X-rays. UV radiation is present in sunlight, and is produced by electric arcs and specialized lights. Thus it is present in normal ambient conditions. Thus, a user may use the UV light 108 to increase cure speed (i.e., decrease cure time). However, one of skill in the art will appreciate that cure will occur (but may be slower) without the use of the UV light as long as UV light is present.

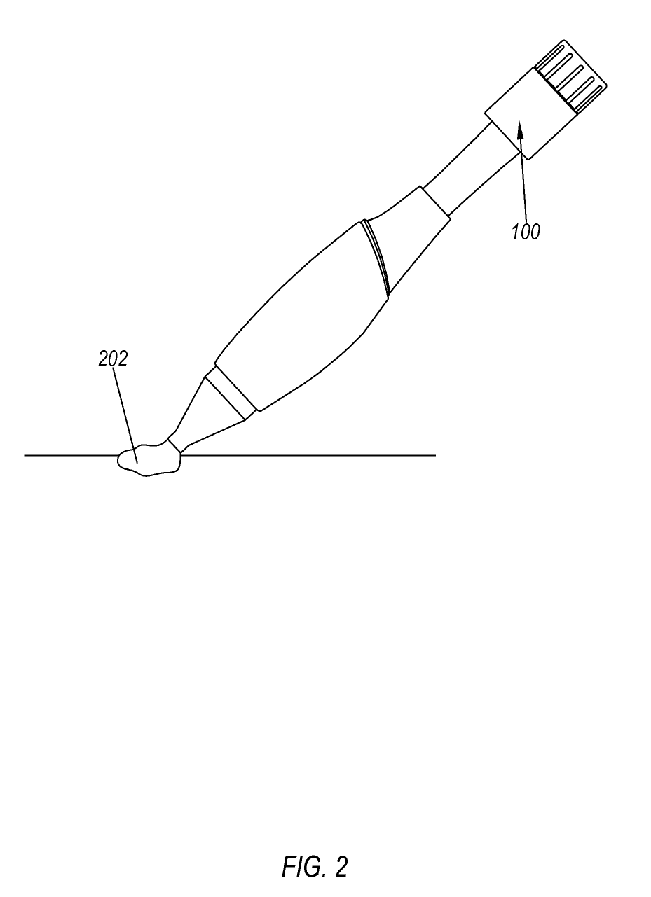

FIG. 2 illustrates an example of a UV pen 100 in use. The UV pen 100 can allow a user to create a repair. In particular, the UV pen 100 can be used to dispense a repair material into a location desired by a user.

FIG. 2 shows that the UV pen 100 can eject a UV activated hardening material 202. The UV activated hardening material 202 is stored within the cavity 102. The UV activated hardening material 202 can include any compound which is configured to harden when exposed to UV radiation. I.e., the UV activated hardening material 202 will be cured and harden into a set configuration. The cured UV activated hardening material 202 then completes the repair. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

The UV activated hardening material 202 can have a viscosity based on the type of application. Low viscosity allows a user to have more time to work with the resin before hardening and means that adjoining drops of UV activated hardening material 202 may more easily combine into a single pool of UV hardening material. In contrast, high viscosity ensures that the volume of the UV activating hardening material before and after curing is substantially similar and may provide stronger adhesion. Viscosity of a fluid is a measure of its resistance to gradual deformation by shear stress or tensile stress. For liquids, it corresponds to the informal concept of “thickness”. For example, honey has a much higher viscosity than water. Except for superfluids at very low temperatures all fluids have positive viscosity. In common parlance however, a liquid is said to have high viscosity if its viscosity is greater than that of water; and may be described as having low viscosity, if the viscosity is less than water.

The UV activated hardening material 202 can include any desired material. For example, the UV activated hardening material 202 can include resin (a liquid that will set into a hard lacquer or enamel-like finish) or any other hardening material. For example, the UV activated hardening material 202 can include a resin which includes, by weight, 20-50% urethane acrylate, 15-30% epoxy acrylate, 15-30% trimethylolpropane triacrylate, and 2-10% photoinitiator.

A photoinitiator is any chemical compound that decomposes into free radicals when exposed to light. In particular, the photoinitiator begins a chemical process, when exposed to UV light, which initiates hardening of the UV activated hardening material 202. Additionally or alternatively, the photoinitiator can begin a chemical reaction that changes the color of the UV hardening material 202. For example, the above example of a UV activated hardening material 202 is an amber yellow color before curing and is clear after curing. Thus, a user can visually determine if curing has occurred.

FIG. 1 further shows that the UV pen 100 can include an additive 106. For example, the additive 106 can include plastic, rubber, sand, wood particles, sawdust, or any other desired additive. The additives may or may not be biodegradable. In addition, the additives can be substantially non-toxic, allowing them to be handled during application and to repair items where non-toxic resins would be desirable, for example in repairing items that will carry drinking water.

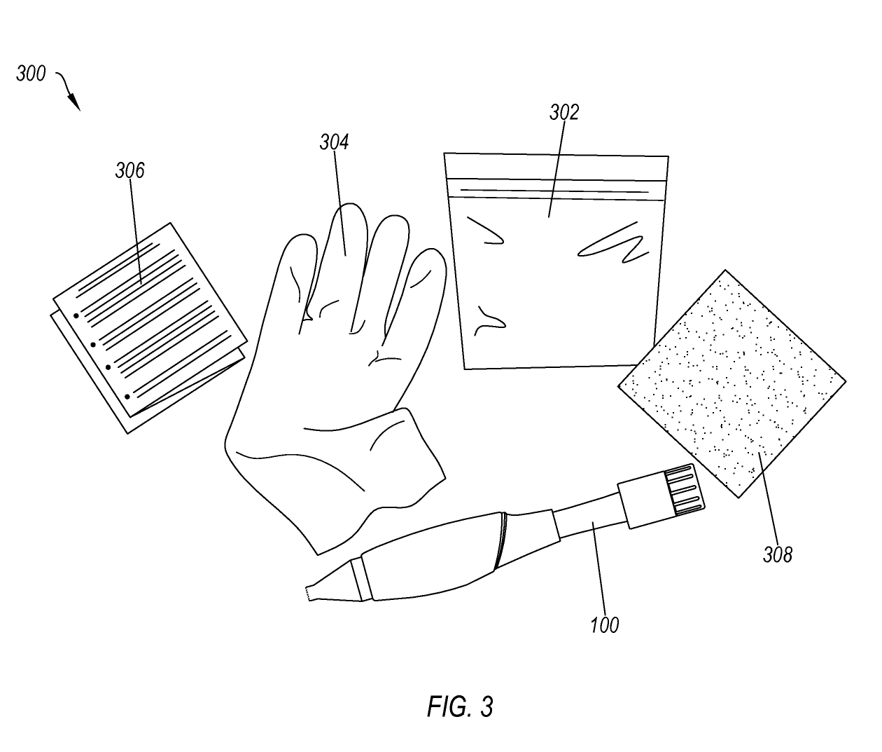

FIG. 3 illustrates an example of a repair kit 300. The repair kit 300 can include all of the material required for a user to repair or strengthen an object. In particular, the repair kit 300 can allow a user to purchase, in a single transaction, all required elements to perform a repair and/or strengthen an inanimate object.

FIG. 3 shows that the repair kit 300 can include UV pen 100. The UV pen 100 can include a cavity and a UV activated hardening material. Because the cavity prevents curing of the UV activated hardening material, the UV pen 100 need not be have only enough material for a single repair. I.e., the UV pen 100 can have enough UV activated hardening material to complete several repairs.

FIG. 3 further shows that the repair kit 300 can include gloves 304. The gloves 304 can allow the user to handle the UV pen 100 without getting the UV activated hardening material on his/her hands. Additionally or alternatively, the gloves 304 can prevent the user from contaminating the UV activated hardening material in the UV pen 100. I.e., the UV activated hardening material can include chemicals that may otherwise irritate the user's skin, which can be prevented by the gloves 304.

FIG. 3 additionally shows that the repair kit 300 can include instructions 306. The instructions 306 can include information about the UV pen 100 and how it can be best used to affect the desired repair. Additionally or alternatively, the instructions 306 can include information about where instructions, tips, repair examples, or other information can be found. I.e., the instructions 306 can include a website or other information that will tell a user where to find required information such as instructional videos.

FIG. 3 moreover shows that the repair kit 300 can include surface preparation materials 308. Surface preparation materials 308 can include sand paper or other abrasive material for cleaning and roughing up the surface, a cleaning towel or agent, and or a bonding agent to increase the adhesive properties. Additionally or alternatively, surface preparation materials 308 can include paint or other materials configured to change the appearance of the hardened UV pen 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A UV pen for repairing inanimate objects, the UV pen comprising:
a cavity; and
a UV activated hardening material, wherein the UV activated hardening material:
is stored within the cavity; and
hardens when exposed to UV radiation.

2. The UV pen of claim 1 further comprising a grip, wherein the grip is configured to allow a user to handle the UV pen.

3. The UV pen of claim 1 further comprising a grip, wherein the grip includes a non-slip material.

4. The UV pen of claim 1, wherein the cavity includes a material that blocks UV light.

5. The UV pen of claim 1, wherein the UV activated hardening material includes an additive disposed in the UV activated hardening material.

6. The UV pen of claim 5, wherein the additive includes at least one of:
plastic;
rubber;
sand;
wood particles; or
sawdust.

7. The UV pen of claim 1, wherein the UV activated hardening material is amber yellow before curing.

8. The UV pen of claim 1, wherein the UV activated hardening material is transparent after curing.

9. The UV pen of claim 1, wherein the UV activated hardening material has a low viscosity.

10. The UV pen of claim 1, wherein the UV activated hardening material has a high viscosity.

11. The UV pen of claim 1, wherein the UV activated hardening material includes a resin.

12. A UV pen for repairing inanimate objects, the UV pen comprising:
a cavity, wherein the cavity is configured to deform under pressure;
a UV activated hardening material, wherein the UV activated hardening material:
is stored within the cavity;
hardens when exposed to UV radiation;
is amber yellow before curing; and
is transparent after curing;
a tip, wherein the tip:
is connected to the cavity; and
allows UV activated hardening material to exit the cavity when pressure is placed on the cavity; and
a UV light, wherein the UV light has a low divergence angle.

13. The UV pen of claim 12, wherein the UV light includes an LED.

14. The UV pen of claim 12, wherein the UV activated resin includes:
20-50% urethane acrylate by weight.

15. The UV pen of claim 12, wherein the UV activated resin includes:
15-30% epoxy acrylate by weight.

16. The UV pen of claim 12, wherein the UV activated resin includes:
15-30% trimethylolpropane triacrylate by weight.

17. The UV pen of claim 12, wherein the UV activated resin includes:
2-10% photoinitiator by weight.

18. The UV pen of claim 12 further comprising a cap configured to cover the tip.

19. A repair kit for repairing an inanimate object, the repair kit comprising:
a UV pen, wherein the UV pen includes:
a cavity, wherein the cavity is configured to deform under pressure;
a UV activated hardening material, wherein the UV activated hardening material:
is stored within the cavity; and
hardens when exposed to UV radiation;
a tip, wherein the tip:
is connected to the cavity; and
allows UV activated hardening material to exit the cavity when pressure is placed on the cavity; and
a UV light;
a pair of gloves;
instructions; and
a surface preparation material configured to allow a user to finish the UV hardening material after curing.

20. The UV pen of claim 19, wherein the surface preparation material includes at least one of:
sand paper;
a cutting tool;
a buffing tool;
a smoothing tool;
a shaping tool;
a forming tool;
a texturing tool;
a paint;
a sealing material; or
a priming material.
